(19) United States
(12) Patent Application Publication
(10) Pub. No.: US 2011/0286597 A1
(43) Pub. Date: Nov. 24, 2011

(54) HOME AGENT PROXIED MIPv6 ROUTE OPTIMIZATION MODE

(75) Inventors: Wassim Michel Haddad, San Diego, CA (US); Georgios Tsirtsis, (US); Gerardo Giaretta, San Diego, CA (US)

(73) Assignee: QUALCOMM INCORPORATED, San Diego, CA (US)

(21) Appl. No.: 12/947,183

(22) Filed: Nov. 16, 2010

Related U.S. Application Data
(60) Provisional application No. 61/262,085, filed on Nov. 17, 2009.

(51) Int. Cl. H04W 12/00

(52) U.S. Cl. 380/270

(57) ABSTRACT

A method apparatus, processor, and computer program product for wireless communication, including employing a communication interface to obtain a binding update message from a mobile node (MN). A data process is employed to analyze the binding update message for a network address of a corresponding node (CN). A communication interface is employed to initiate a long-life secure association between the CN and a network agent serving the MN if the binding update message contains the network address of the CN, wherein the long-life secure association enables the MN and CN to participate in a route optimized (RO) mobile communication session. The method may include employing a data processor to generate a binding cache entry for the network entity or a network component serving the network entity, wherein the binding cache entry includes a security key that facilitates a route optimized communication session with the network entity or the network component.

### CLAIM OF PRIORITY UNDER 35 U.S.C. §119

The present Application for Patent claims priority to Provisional Application No. 61/262,085 entitled “HOME AGENT PROXIED MIPv6 ROUTE OPTIMIZATION MODE” filed Nov. 17, 2009, and assigned to the assignee hereof and hereby expressly incorporated by reference herein.

### BACKGROUND

1. Field

The following relates generally to wireless communication, and more specifically to providing optimized signaling for high-speed wireless communication.

2. Background

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, 3GPP Long Term Evolution (LTE) systems, and orthogonal frequency division multiple access (OFDMA) systems.

Generally, a wireless multiple-access communication system can simultaneously support communication for multiple wireless terminals. Each terminal communicates with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-in-single-out, multiple-in-signal-out or a multiple-in-multiple-out (MIMO) system.

Recent advances in mobile communication involve integration of mobile networks and Internet Protocol (IP) based networks. This integration enables a vast amount of multimedia resources available over IP-type networks to be accessible on mobile phones, laptop computers, and so forth. In addition, this integration has enabled high quality voice communication, including circuit-switched and packet-switched communication, to be available over various types of network interface mechanisms (e.g., wireless local area network, Broadband IP, dial-up, cellular radio network, and so on). In addition, as core network infrastructure advances over time, additional mechanisms for achieving integrated mobile and IP communication are realized. Accordingly, ongoing optimization in wireless communication is a reality for modern wireless communication systems

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

The subject disclosure provides for home agent initiated switchover to route optimized (RO) mobile communication sessions. According to particular aspects disclosed herein, provided is a network implementation that enables a core network home agent to initiate a RO communication for a mobile node served by the home agent. This initiation reduces signaling overhead for the mobile node, potentially reducing network communication delay as well. Furthermore, in at least some aspects, a long-life binding security agreement between a target node and the home agent is achieved, enabling the home agent to initiate additional RO communication sessions for other mobile nodes. Moreover, the additional RO communication sessions can be initiated under the existing long-life binding security agreement, substantially reducing authentication and other overhead involved in establishing such sessions.

In other aspects of the subject disclosure, provided is a method of wireless communication. The method can comprise employing a communication interface to obtain a binding update message from a mobile node (MN). Moreover, the method can comprise employing a data processor to analyze the binding update message for a network address of a corresponding node (CN). In addition to the foregoing, the method can comprise employing the communication interface to initiate a long-life secure association between the CN and a network agent serving the MN if the binding update message contains the network address of the CN, wherein the long-life secure association enables the MN and CN to participate in a RO mobile communication session.

The method of may further include interpreting the binding update message as a request to establish the RO mobile communication session if the binding update message includes the network address of the CN, conditioning initiation of the long-life secure association on determining whether an efficient RO path exists for the MN and CN, and/or initiating a home test initialization (HoTI) message to the CN on behalf of the MN. The method may include at least one of employing a home address (HoA) of the MN as a source address (SA) for the HoTI message; or employing a network address of the network agent serving the MN as the SA and including the HoA of the MN within a payload of the HoTI message. The method may include receiving a security token from the CN in response to the HoTI message.

The method may include obtaining an encrypted message from the MN comprising a care-of security token pertaining to the RO mobile communication session. The encrypted message may be the binding update message, which in turn includes the care-of security token.

Employing the communication interface to initiate the long-life secure association may include sending a second binding update message on behalf of the MN to the CN. The second binding update message may include a network address of the network agent serving the MN as a source address (SA) or a home address (HoA) of the MN and may disclose a cryptographic relationship between the MN and the network agent serving the MN and/or provide a link to a security certificate associated with the network agent serving the MN. The second binding update message may be cryptographically signed by the network agent serving the MN.

The method may include conditioning sending the second binding update message on receiving authentication of a cryptographic relationship between the MN and a network router serving the MN, employing the communication interface to receive a response to the long-life secure association comprising a network agent encryption key, and/or employing the network agent encryption key to generate a long-life bidirectional security association (BSA) between the CN and the network agent serving the MN.

The method may include initiating an additional RO mobile communication session with the CN for a second MN utilizing the network agent encryption key and a network address of the second MN, wherein the additional RO mobile communication session obviates mobility signaling messages between the CN and the second MN, encrypting a care-of address field in a subsequent binding update message sent to the CN as part of the long-life BSA, and/or sending an encryption certificate to the CN as part of the long-life security association to validate the network agent serving the MN with the CN.

In one or more other aspects, disclosed is an apparatus for wireless communication. The apparatus can comprise a communication interface that obtains a binding update message from a MN and a data processor that executes a set of modules configured to provide network triggered RO mobile communication. Furthermore, the set of modules can comprise a scanning module that analyzes the binding update message for a network address of a CN and a transfer module that initiates a long-life secure association between the CN and a network agent serving the MN if the binding update message contains the network address of the CN, wherein the long-life secure association enables the MN and CN to participate in a RO mobile communication session.

The scanning module may be configured to interpret the binding update message as a request to establish the RO mobile communication session if the binding update message includes the network address of the CN. The transfer module may be configured to condition initiation of the long-life secure association based on determining whether an efficient RO path exists for the MN and CN. The transfer module may be configured to initiate a home test initialization (HoTI) message to the CN on behalf of the MN. A home address (HoA) of the MN may be used as a source address (SA) for the HoTI message; or a network address of the network agent serving the MN may be used as the SA and including the HoA of the MN within a payload of the HoTI message. The communication interface may be configured to receive a security token from the CN in response to the HoTI message. The processor may be configured to obtain an encrypted message from the MN comprising a care-of security token pertaining to the RO mobile communication session. The encrypted message may be the binding update message, which in turn includes the care-of security token. The communication interface may be further configured to send a second binding update message on behalf of the MN to the CN.

The second binding update message may include a network address of the network agent serving the MN as a source address (SA). The second binding update message may: include a home address (HoA) of the MN, disclose a cryptographic relationship between the MN and the network agent serving the MN, provide a link to a security certificate associated with the network agent serving the MN, and/or be cryptographically signed by the network agent serving the MN.

The communication interface may be further configured to condition sending the second binding update message on receiving authentication of a cryptographic relationship between the MN and a network router serving the MN. The communication interface may be configured to receive a response to the long-life secure association comprising a network agent encryption key, wherein the processor is configured to use the network agent encryption key to generate a long-life bidirectional security association (BSA) between the CN and the network agent serving the MN.

The transfer module may be further configured to initiate an additional RO mobile communication session with the CN for a second MN utilizing the network agent encryption key and a network address of the second MN, wherein the additional RO mobile communication session obviates mobility signaling messages between the CN and the second MN. The processor may be further configured to encrypt a care-of address field in a subsequent binding update message sent to the CN as part of the long-life BSA. The communication interface may be further configured to send an encryption certificate to the CN as part of the long-life security association to validate the network agent serving the MN with the CN.

According to still other aspects, provided is an apparatus for wireless communication. The apparatus can comprise means for obtaining a binding update message from a MN and means for analyzing the binding update message for a network address of a CN. Moreover, the apparatus can also comprise means for initiating a long-life secure association between the CN and a network agent serving the MN if the binding update message contains the network address of the CN, wherein the long-life secure association enables the MN and CN to participate in a RO mobile communication session.

In one or more additional aspects, disclosed is at least one processor configured for wireless communication. The processor(s) can comprise a module that obtains a binding update message from a MN. Further, the processor(s) can comprise a module that analyzes the binding update message for a network address of a CN. Further to the above, the processor(s) can also comprise a module that initiates a long-life secure association between the CN and a network agent serving the MN if the binding update message contains the network address of the CN, wherein the long-life secure association enables the MN and CN to participate in a RO mobile communication session.

According to another aspect, provided is a computer program product comprising a computer-readable medium. The computer program product can comprise code for causing a computer to obtain a binding update message from a MN. In addition, the computer program product can comprise code for causing the computer to analyze the binding update message for a network address of a CN. Moreover, the computer program product can also comprise code for causing the computer to initiate a long-life secure association between the CN and a network agent serving the MN if the binding update message contains the network address of the CN, wherein the long-life secure association enables the MN and CN to participate in a RO mobile communication session.

In an additional aspect disclosed is a method of wireless communication. The method can comprise employing a data processor to identify a network address of a recipient node (RN) of an intended mobile communication session. Further, the method can comprise employing a communication interface to send a binding update message to a home agent that includes the network address of the RN. Moreover, the method can also comprise employing the communication interface to receive a binding acknowledgement from the home agent indicating approval to establish a RO mobile communication session with the RN. The approval of an established route optimized communication session with the RN may be based in part on a security token from a Home Test (HOT) message from the RN and in part on a security token from a Care-of-Test (COT) message from the RN.

Other aspects include an apparatus for wireless communication, comprising: a data processor configured to identify a network address of a recipient node (RN) of an intended mobile communication session; and a communication interface configured to send a binding update message to a home agent that includes the network address of the RN and to receive a binding acknowledgement from the home agent indicating approval to establish a route optimized (RO) mobile communication session with the RN. The approval of an established route optimized communication session with the RN may be based in part on a security token from a Home Test (HOT) message from the RN and in part on a security token from a Care-of-Test (COT) message from the RN.

In yet another aspect the subject disclosure provides an apparatus for wireless communication. The apparatus can comprise means for identifying a network address of a RN of an intended mobile communication session. In addition, the apparatus can comprise means for sending a binding update message to a home agent that includes the network address of the RN. Furthermore, the apparatus can comprise means for receiving a binding acknowledgement from the home agent indicating approval to establish a RO mobile communication session with the RN.

In one or more additional aspects is disclosed at least one processor configured for wireless communication. The processor(s) can comprise a module that identifies a network address of a RN of an intended mobile communication session. Further, the processor(s) can comprise a module that sends a binding update message to a home agent that includes the network address of the RN. In addition to the foregoing, the processor(s) can comprise a module that receives a binding acknowledgement from the home agent indicating approval to establish a RO mobile communication session with the RN.

According to yet other aspects, the subject disclosure provides a computer program product comprising a computer-readable medium. The computer-readable medium can comprise code for causing a computer to identify a network address of a RN of an intended mobile communication session. Furthermore, the computer-readable medium can comprise code for causing the computer to send a binding update message to a home agent that includes the network address of the RN. In addition, the computer-readable medium can also comprise code for causing the computer to receive a binding acknowledgement from the home agent indicating approval to establish a RO mobile communication session with the RN.

According to another aspect the subject disclosure provides a method of wireless communication. The method can comprise employing a communication interface to obtain an initialization message pertaining to a desired mobile communication session. Furthermore the method can comprise employing at least one data processor to verify the initialization message and extract a network address of a network entity transmitting the initialization message upon successful verification. Additionally, the method can also comprise employing the at least one data processor to generate a binding cache entry for the network entity or a network component serving the network entity, wherein the binding cache entry includes a security key that facilitates a route optimized communication session with the network entity or the network component. The method may further include transmitting at least a portion of the security key in a Home Test (HOT) message. The method may further include transmitting at least a portion of the security key in a Care-of-Test (COT) message.

Additional aspects include an apparatus for wireless communication, comprising: a communication interface configured to obtain an initialization message pertaining to a desired mobile communication session; and at least one data processor configured to verify the initialization message and extract a network address of a network entity transmitting the initialization message upon successful verification and to generate a binding cache entry for the network entity or a network component serving the network entity, wherein the binding cache entry includes a security key that facilitates a route optimized communication session with the network entity or the network component. The communication interface may be configured to transmit at least a portion of the security key in a Home Test (HOT) message. The communication interface may be configured to transmit at least a portion of the security key in a Care-of-Test (COT) message.

In one or more other aspects an apparatus for wireless communication is provided. The apparatus can comprise means for obtaining an initialization message pertaining to a desired mobile communication session. Additionally, the apparatus can comprise means for verifying the initialization message and extract a network address of a network entity transmitting the initialization message upon successful verification. Also, the apparatus can comprise means for generating a binding cache entry for the network entity or a network component serving the network entity, wherein the binding cache entry includes a security key that facilitates a route optimized communication session with the network entity or the network component.

In another aspect is provided at least one processor configured for wireless communication. The processor(s) can comprise a module that obtains an initialization message pertaining to a desired mobile communication session. Additionally, the processor(s) can also comprise a module that verifies the initialization message and extract a network address of a network entity transmitting the initialization message upon successful verification. Further to the above, the processor(s) can comprise a module that generates a binding cache entry for the network entity or a network component serving the network entity, wherein the binding cache entry includes a security key that facilitates a route optimized communication session with the network entity or the network component.

According to still other aspects the subject disclosure provides a computer program product comprising a computer-readable medium. The computer-readable medium can include code for causing a computer to obtain an initialization message pertaining to a desired mobile communication session. In addition the computer-readable medium can also include code for causing the computer to verify the initialization message and extract a network address of a network entity transmitting the initialization message upon successful verification. Moreover, the computer-readable medium can include code for causing the computer to generate a binding cache entry for the network entity or a network component serving the network entity, wherein the binding cache entry includes a security key that facilitates a route optimized communication session with the network entity or the network component.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates a block diagram of an example wireless environment suitable for network to mobile communication.

FIG. 2 depicts a block diagram of an example wireless transmit-receive chain facilitating wireless communication according to some aspects.

FIG. 3 illustrates a block diagram of an example route optimization trigger apparatus according to aspects of the subject disclosure.

FIG. 4 illustrates a network message diagram for an example home agent triggered route optimization call according to further aspects disclosed herein.

FIG. 5 depicts a flowchart of an example methodology for providing network-triggered route optimization mobile communications.

FIG. 6 depicts a flowchart of a sample methodology for requesting a network-triggered route optimization session according to further disclosed aspects.

FIG. 7 illustrates a flowchart of an example methodology for facilitating a route optimized communication session according to still other aspects.

FIG. 8 illustrates a block diagram of an example apparatus for network-initiated route optimization for mobile communications according to other aspects.

FIG. 9 depicts a block diagram of a sample apparatus for requesting network-triggered route optimized communication according to other aspects.

FIG. 10 illustrates a block diagram of an example apparatus for facilitating efficient route optimized communication according to yet other aspects disclosed herein.

FIG. 11 illustrates a block diagram of an example MIPv6 environment.

FIG. 12 illustrates a block diagram of an example MIPv6 environment employing route optimization.

FIG. 13 illustrates an exemplary network message diagram for a home agent triggered route optimization call.

### DETAILED DESCRIPTION

Mobile IP is a protocol that can be used between end mobile devices, or mobile node (MN), and a home agent (HA). As an MN moves between different access points, in order to maintain connection, an IP address is obtained from the MN's current access point. This address is sent to the HA to update the MN's location. Packets from a corresponding node (CN) that are received by the HA for the MN are then routed to the temporary location. Route Optimization (RO) removes the need to route the packet via the HA, by establishing a tunnel between the MN and the CN. This allows packets to be tunneled directly from the CN to the MN in a faster, more efficient manner. This reduces delay and the amount of traffic being handled by the HA. Aspects described herein involve the HA in the determination process for establishing RO. The HA has a better knowledge of the network structure. Thus, the HA is in a better position to determine whether a direct route between the MN and CN is better than the indirect route via the HA. Further, in circumstances when the CN is a large server, it may be beneficial to establish a security association between the large CN and the HA so that this association can be used with a number of individual MNs served by the HA. This can reduce the overall amount of signaling traffic.

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The techniques described herein can be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network can implement a radio technology such as Universal Terrestrial Radio Access (UTRA), CDMA2000, etc. UTRA includes Wideband-CDMA (W-CDMA) and Low Chip Rate (LCR). CDMA2000 covers IS-2000, IS-95 and IS-856 standards. A TDMA network can implement a radio technology such as Global System for Mobile Communications (GSM). An OFDMA network can implement a radio technology such as Evolved UTRA (E-UTRA), IEEE 802.11, IEEE 802.16, IEEE 802.20, Flash-OFDM, etc. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS and LTE are described in documents from an organization named “3rd Generation Partnership Project” (3GPP). CDMA2000 is described in documents from an organization named “3rd Generation Partnership Project 2” (3GPP2). These various radio technologies and standards are known in the art. For clarity, certain aspects of the techniques are described below for LTE, and LTE terminology is used in much of the description below.

Single carrier frequency division multiple access (SC-FDMA), which utilizes single carrier modulation and frequency domain equalization is a technique. SC-FDMA has similar performance and essentially the same overall complexity as those of OFDMA system. SC-FDMA signal has lower peak-to-average power ratio (PAPR) because of its inherent single carrier structure. SC-FDMA has drawn great attention, especially in the uplink communications where lower PAPR greatly benefits the mobile terminal in terms of transmit power efficiency. It is currently a working assumption for uplink multiple access scheme in 3GPP Long Term Evolution (LTE), or Evolved UTRA.

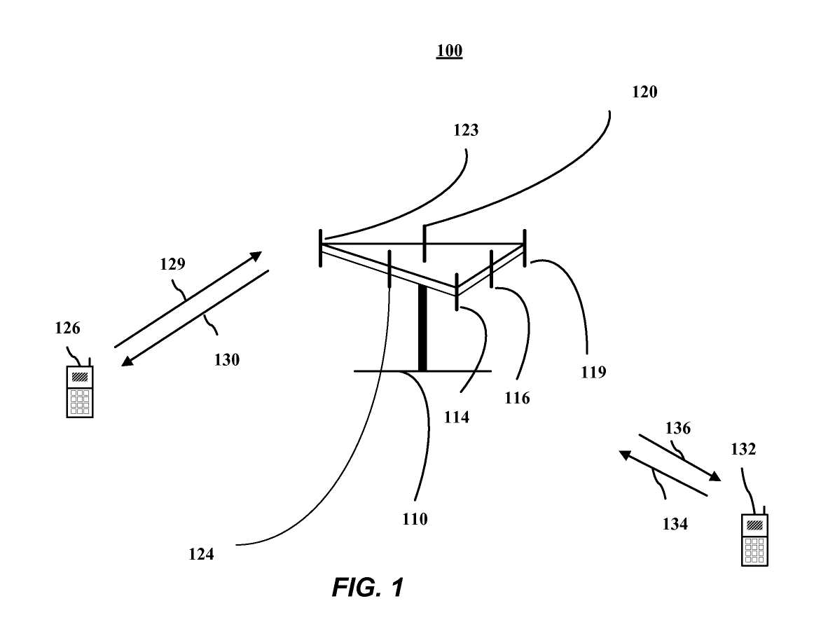

Referring to FIG. 1, a multiple access wireless communication system 100 according to one embodiment is illustrated. An access point 110 (AP) includes multiple antenna groups, one including 119 and 120, another including 123 and 124, and an additional including 114 and 116. In FIG. 1, only two antennas are shown for each antenna group, however, more or fewer antennas can be utilized for each antenna group. Access terminal 126 (AT) (erg., a user equipment or UE) is in communication with antennas 123 and 124, where antennas 123 and 124 transmit information to access terminal 126 over forward link 130 and receive information from access terminal 126 over reverse link 129. Access terminal 132 is in communication with antennas 114 and 116, where antennas 114 and 116 transmit information to access terminal 132 over forward link 136 and receive information from access terminal 132 over reverse link 134. In a FDD system, communication links 129, 130, 134 and 136 can use different frequency for communication. For example, forward link 130 can use a different frequency then that used by reverse link 129.

Each group of antennas and/or the area in which they are designed to communicate is often referred to as a sector of the access point. In the embodiment, antenna groups each are designed to communicate to access terminals in a sector, of the areas covered by access point 110.

In communication over forward links 130 and 136, the transmitting antennas of access point 110 utilize beamforming in order to improve the signal-to-noise ratio of forward links for the different access terminals 126 and 132. Also, an access point using beamforming to transmit to access terminals scattered randomly through its coverage causes less interference to access terminals in neighboring cells than an access point transmitting through a single antenna to all its access terminals.

An access point can be a fixed station used for communicating with the terminals and can also be referred to as an access point, a Node B, or some other terminology. An access terminal can also be called an access terminal, user equipment (UE), a wireless communication device, terminal, access terminal or some other terminology.

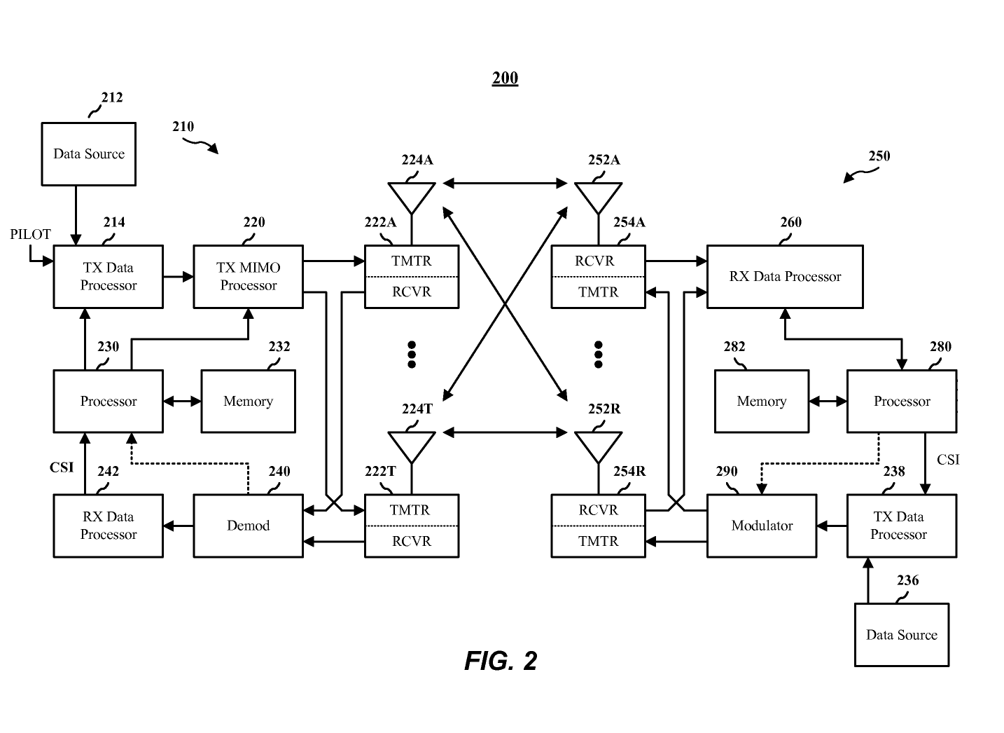

FIG. 2 is a block diagram of an embodiment of a transmitter system 210 (also known as the access point) and a receiver system 250 (also known as access terminal) in a MIMO system 200. At the transmitter system 210, traffic data for a number of data streams is provided from a data source 212 to a transmit (TX) data processor 214.

In an embodiment, each data stream is transmitted over a respective transmit antenna. TX data processor 214 formats, codes, and interleaves the traffic data for each data stream based on a particular coding scheme selected for that data stream to provide coded data.

The coded data for each data stream can be multiplexed with pilot data using OFDM techniques. The pilot data is typically a known data pattern that is processed in a known manner and can be used at the receiver system to estimate the channel response. The multiplexed pilot and coded data for each data stream is then modulated (e.g., symbol mapped) based on a particular modulation scheme (e.g., BPSK, QSPK, M-PSK, or M-QAM) selected for that data stream to provide modulation symbols. The data rate, coding, and modulation for each data stream can be determined by instructions performed by processor 230.

The modulation symbols for all data streams are then provided to a TX MIMO processor 220, which can further process the modulation symbols (e.g., for OFDM). TX MIMO processor 220 then provides N_{T} modulation symbol streams to N_{T} transmitters (TMTR) 222A through 222T. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222A through 222T are then transmitted from N_{T} antennas 224A through 224T, respectively.

At receiver system 250, the transmitted modulated signals are received by N_{R} antennas 252A through 252R and the received signal from each antenna 252 is provided to a respective receiver (RCVR) 254A through 254R. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 280 periodically determines which pre-coding matrix to use (discussed below). Processor 280 formulates a reverse link message comprising a matrix index portion and a rank value portion.

The reverse link message can comprise various types of information regarding the communication link and/or the received data stream. The reverse link message is then processed by a TX data processor 238, which also receives traffic data for a number of data streams from a data source 236, modulated by a modulator 290, conditioned by transmitters 254A through 254R, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reverse link message transmitted by the receiver system 250. Processor 230 then determines which pre-coding matrix to use for determining the beamforming weights then processes the extracted message.

In an aspect, logical channels are classified into Control Channels and Traffic Channels. Logical Control Channels comprise Broadcast Control Channel (BCCH) which is a DL channel for broadcasting system control information. Paging Control Channel (PCCH) which is a DL channel that transfers paging information. Multicast Control Channel (MCCH) which is a Point-to-multipoint DL channel used for transmitting Multimedia Broadcast and Multicast Service (MBMS) scheduling and control information for one or several Multicast Traffic Channels (MTCH)s. Generally, after establishing RRC connection this channel is only used by UEs that receive MBMS (Note: old MCCH+MSCH). Dedicated Control Channel (DCCH) is a Point-to-point bi-directional channel that transmits dedicated control information and used by UEs having an RRC connection. In an aspect, Logical Traffic Channels comprise a Dedicated Traffic Channel (DTCH) which is a Point-to-point bi-directional channel, dedicated to one UE, for the transfer of user information. Also, the Logical Traffic Channels can comprise a MTCH for Point-to-multipoint DL channel for transmitting traffic data.

In an aspect, Transport Channels are classified into DL and UL. DL Transport Channels comprises a Broadcast Channel (BCH), Downlink Shared Data Channel (DL-SDCH) and a Paging Channel (PCH), the PCH for support of UE power saving (DRX cycle is indicated by the network to the UE), broadcasted over an entire cell and mapped to PHY resources which can be used for other control/traffic channels. The UL Transport Channels comprise a Random Access Channel (RACH), a Request Channel (REQCH), an Uplink Shared Data Channel (UL-SDCH) and a plurality of PHY channels. The PHY channels comprise a set of DL channels and UL channels.

The DL PHY channels comprise a Common Pilot Channel (CPICH), Synchronization Channel (SCH), Common Control Channel (CCCH), Shared DL Control Channel (SDCCH), Multicast Control Channel (MCCH), and Shared UL Assignment Channel (SUACH). Furthermore, the DL PHY channels can comprise an Acknowledgement Channel (ACKCH), DL Physical Shared Data Channel (DL-PSDCH), UL Power Control Channel (UPCCH), Paging Indicator Channel (PICH), and a Load Indicator Channel (LICH).

The UL PHY Channels comprise a Physical Random Access Channel (PRACH), Channel Quality Indicator Channel (CQICH), and Acknowledgement Channel (ACKCH). Further, the UL PHY channels comprise an Antenna Subset Indicator Channel (ASICH), Shared Request Channel (SREQCH), UL Physical Shared Data Channel (UL-PSDCH), and a Broadband Pilot Channel (BPICH).

For the purposes of the present document, the following abbreviations apply:

AM Acknowledged Mode

AMD Acknowledged Mode Data

ARQ Automatic Repeat Request

BCCH Broadcast Control CHannel

BCH Broadcast CHannel

C- Control-

CCCH Common Control CHannel

CCH Control CHannel

CCTrCH Coded Composite Transport Channel

CP Cyclic Prefix

CRC Cyclic Redundancy Check

CTCH Common Traffic CHannel

DCCH Dedicated Control CHannel

DCH Dedicated CHannel

DL DownLink

DSCH Downlink Shared CHannel

DTCH Dedicated Traffic CHannel

FACH Forward link Access CHannel

FDD Frequency Division Duplex

L1 Layer 1 (physical layer)

L2 Layer 2 (data link layer)

L3 Layer 3 (network layer)

LI Length Indicator

LSB Least Significant Bit

MAC Medium Access Control

MBMS Multimedia Broadcast Multicast Service

MCCHMBMS point-to-multipoint Control CHannel

MRW Move Receiving Window

MSB Most Significant Bit

MSCH MBMS point-to-multipoint Scheduling CHannel

MTCH MBMS point-to-multipoint Traffic CHannel

PCCH Paging Control CHannel

PCH Paging CHannel

PDU Protocol Data Unit

PHY PHYsical layer

PhyCH Physical CHannels

RACH Random Access CHannel

RLC Radio Link Control

RRC Radio Resource Control

SAP Service Access Point

SDU Service Data Unit

SHCCH SHared channel Control CHannel

SN Sequence Number

SUFI SUper FIeld

TCH Traffic CHannel

TDD Time Division Duplex

TFI Transport Format Indicator

TM Transparent Mode

TMD Transparent Mode Data

TTI Transmission Time Interval

U- User-

UE User Equipment

UL UpLink

UM Unacknowledged Mode

UMD Unacknowledged Mode Data

UMTS Universal Mobile Telecommunications System

UTRA UMTS Terrestrial Radio Access

UTRAN UMTS Terrestrial Radio Access Network

MBSFN Multicast Broadcast Single Frequency Network

MCE MBMS Coordinating Entity

MCH Multicast CHannel

DL-SCH DownLink Shared CHannel

MSCH MBMS Control CHannel

PDCCH Physical Downlink Control CHannel

PDSCH Physical Downlink Shared Channel

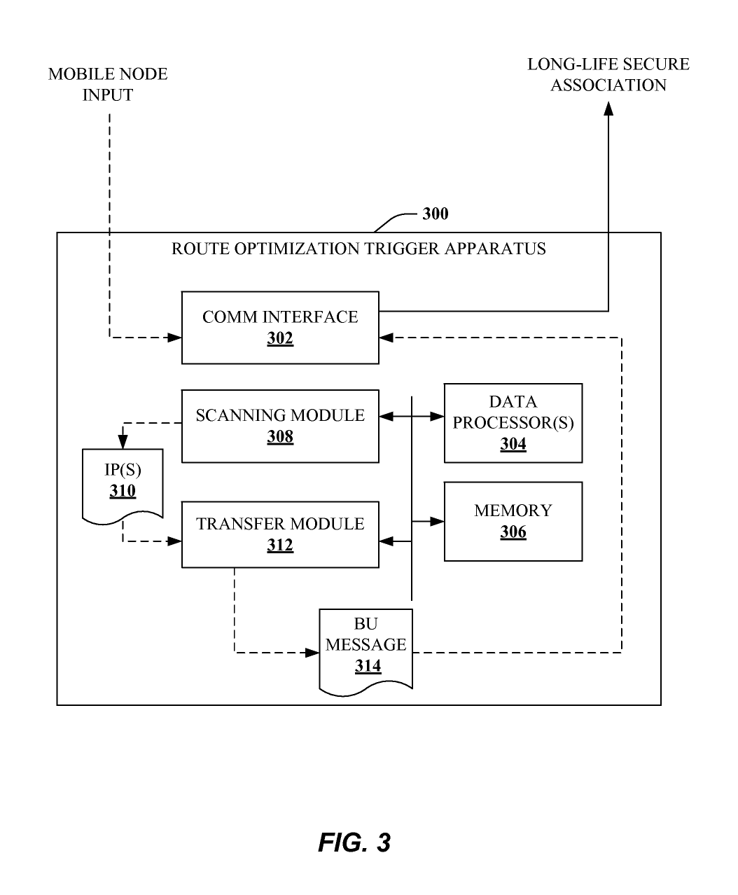

FIG. 3 illustrates a block diagram of an example apparatus 300 for providing network-initiated route optimization, according to one or more aspects of the subject disclosure. Particularly, disclosed is a route optimization (RO) trigger apparatus 300. RO trigger apparatus 300 can be implemented in conjunction with a network component that provides mobility management for mobile communication devices (e.g., laptop computer, mobile telephone, mobile communication device, personal digital assistant, smartphone, and so on). As a particular example, RO trigger apparatus 300 can be implemented in conjunction with a home agent of a service provider's core network. In this context, the home agent can be a network component responsible for routing traffic to a mobile communication device that is not within a home network, not currently associated with a home network address, or the like.

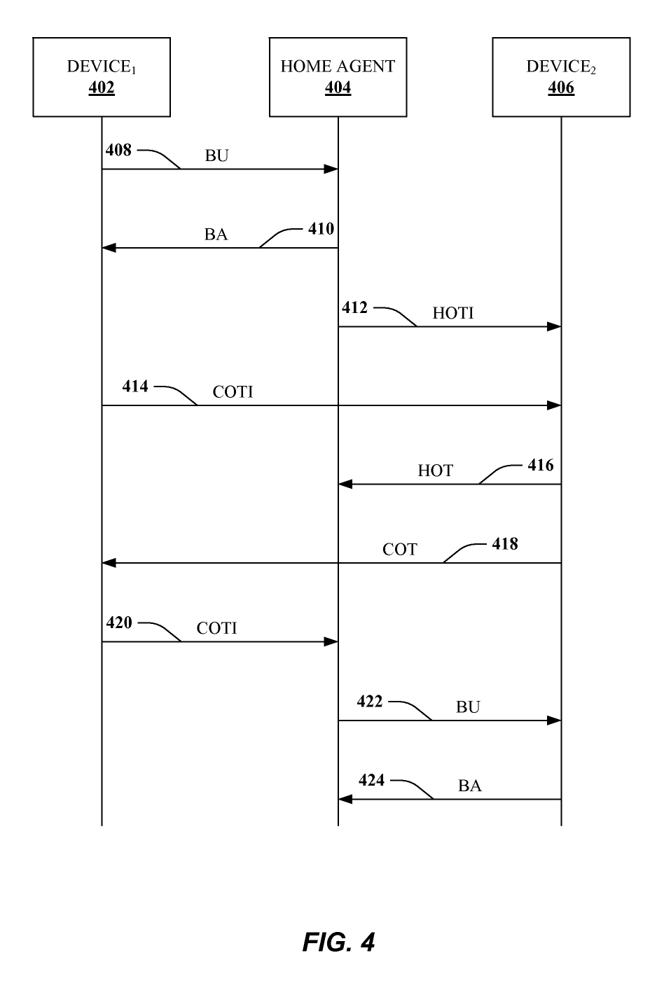

RO trigger apparatus 300 can comprise a communication interface 302 for sending and receiving electronic data with remotely located communication devices (not depicted). Communication interface 302 can comprise a wired communication interface (e.g., an Ethernet interface, a digital subscriber line [DSL] interface, a cable modem interface, a T1 or T3 interface, and so on) or a wireless communication interface (e.g., wireless local area network, wireless wide area network, worldwide interoperability for microwave access [WiMAX], cellular communication network), or a combination thereof. According to particular aspects of the subject disclosure, communication interface 302 can obtain an electronic message from a mobile node (MN) served by the home agent coupled with RO trigger apparatus 302. The electronic message can specify an address binding that associates a home address (HoA) of the MN with a care-of address (CoA) of the MN, also referred to as a local address. RO trigger apparatus 300 can store the HoA with the CoA in memory 306 for routing traffic to the MN from remote devices (not depicted, but see FIG. 4, infra). Thus, upon receiving traffic transmitted to the HoA, the home agent can forward the traffic to the CoA, facilitating mobile roaming communication for the MN.

In addition to the foregoing, RO trigger apparatus 300 can comprise one or more data processors 304 that execute a set of modules (308, 312) configured to initiate RO mobile communication for the MN. Specifically, processor(s) 304 can execute a scanning module 308 upon receiving the electronic message from the MN. In one aspect, scanning module 308 analyzes the electronic message to identify an explicit request for such RO mobile communication. In another aspect, scanning module 308 analyzes the electronic message to identify an inferred request for such communication. In this context, scanning module 308 first determines whether a network address of another network node (e.g., a corresponding node [CN]) is included in the electronic message. If such a network address is found, scanning module 308 can infer a request for RO mobile communication.

If an explicit or inferred request for RO communication is identified by scanning module 308, a network address of a CN is extracted from the electronic message and provided to a transfer module 312. Processor(s) 304 executes transfer module 312 to initiate a long-life secure association between the CN and the home agent serving the MN. The long-life secure association can enable the MN and the CN to participate in a RO mobile communication session.

To initiate the long-life secure association, transfer module 312 generates a binding update (BU) message 314 and forwards BU message 314 to the CN via communication interface 302. In one aspect of the subject disclosure, transfer module 312 includes the HoA of the MN as a source address (SA) of BU message 314. In an alternative aspect, transfer module 312 includes a network address of the home agent as the SA, and includes the HoA of the MN within a payload of BU message 314. In either case, the CN can extract the HoA of the MN from the BU message 314, and can utilize either the HoA or network address of the home agent to send a binding acknowledgement (BA) message in response to BU message 314. Upon receiving the BA message, RO trigger apparatus 300 can establish security protocols with the CN as part of the long-life secure association.

According to further aspects of the subject disclosure, BU message 314 can include security information of the home agent or the MN to establish the above-mentioned security protocols for the long-life secure association. For instance, BU message 314 can disclose a cryptographic relationship between the home agent and the MN. Alternatively, or in addition, BU message 314 can include a link to a digital certificate associated with the home agent. As yet another option, BU message 314 can be digitally signed with the certificate associated with the home agent. Accordingly, the CN can verify BU message 314 upon receipt, and process BU message 314 only upon successful verification. This procedure can help avoid denial of service attacks against the CN. Specifically, by dropping packets that cannot be successfully verified, additional processing (e.g., validating a digital signature) of received packets is avoided to mitigate incoming denial of service attacks.

If the CN successfully verifies an incoming BU message (314) (e.g., as originating from a valid network home agent), a binding cache entry (BCE) is generated by the CN which associates the home agent and the HoA of the MN with a home agent key (HAK). The HAK can be encrypted (e.g., with a public certificate of the home agent) and sent back to the home agent in the BA message. Upon receiving and processing the BA message and HAK, RO trigger apparatus 300 establishes a long lifetime bidirectional security association (BSA) between the home agent and the CN. This BSA can further enable the home agent to request subsequent RO communication sessions for other MNs served by the home agent. Additionally, these subsequent RO communication sessions can be established with minimal signaling between the home agent and CN. For instance, by sending a second BU message (314) that includes the HAK and a HoA of a second MN (both of which can be encrypted by the RO trigger apparatus 300), RO trigger apparatus 300 can establish an RO communication session between the second MN and the CN. Furthermore, establishing RO communication for the second MN obviates a need for conventional control signaling between the MN and CN, reducing latency for subsequent RO communication sessions. This can lead to added efficiency in mobile communication involving the CN.

Upon creating the BCE for the home agent and the MN, the CN can route traffic directly to the CoA of the MN. The MN, upon receiving and validating this traffic, can then re-route its own transmitted traffic directly to the CN. In general it is assumed that direct traffic between the MN and CN involves a more efficient path between the two devices. However, according to particular aspects of the subject disclosure, RO traffic apparatus 300 can also verify that such an efficient path exists before initiating the long-life secure association. In such a manner, latency can be minimized for communication between the MN and CN.

FIG. 4 illustrates a network communication diagram 400 for facilitating network-initiated RO communication according to further aspects of the subject disclosure. The network communication diagram 400 involves control signal messaging between three network entities, a first device, device₁ 402, a home agent 404 that serves device₁ 402, and a second device, device₂ 406. According to network communication diagram 400, communication is initiated by device₁ 402 in the form of a BU message 408 sent to home agent 404. In response to the BU message 408, home agent 404 extracts a CoA from the BU message 408 and associates the CoA with a HoA of device₁ 402. This association enables home agent 404 to route traffic to and from device₁ 402 when such device is not actively coupled to the HoA.

Furthermore, home agent 404 can analyze the BU message 408 to identify whether a network address of a second device (e.g., device₂ 406) is included therein. If no such network address is found, home agent responds with a binding acknowledgment (BA) message 410 and simply provides routing or mobility services to device₁ 402 per conventional specifications. However, if the network address is present within BU message 408, home agent 404 can attempt to determine whether an efficient network path between device₁ 402 and device₂ 406 exists. If such a path does exist, home agent 404 can specify within BA message 410 that a network-initiated RO communication session will be initiated between device₁ 402 and device₂ 406. In the latter case, home agent 404 generates a home test initialization (HoTI) message 412 on behalf of device₁ 402 and forwards this message 412 to device₂ 406. The HA may use the MN's home address (HoA) as source address in the HoTI message. Alternately, the HA may use its own address as the source address of the HoTI message and the HoA of the MN may be included in the message as the payload. When receiving the HoTI message, the CN replies by sending a HoT message to the same address. The HoT message will be intercepted and processed by the HA. At this point, the HA has the home key gen token.

Additionally, device₁ 402 can generate a care-of test initialization (CoTI) message 414 that tests the reachability of the CoA and forward this message 414 to device₂ 406 as well. Although network communication diagram 400 depicts the HoTI message 412 and CoTI message 414 as being sequentially generated and transmitted to device₂ 406, it should be appreciated that these messages can be transmitted in parallel and thus concurrently. The

Upon receiving the HoTI message 412, device₂ 406 can respond with a home test (HoT) message 416 routed to a network address of the home agent 404, or routed to the HoA (which is intercepted by home agent 404). Device₂ 406 can further include a security token (e.g., a home keygen token) within the HoT message 416. Furthermore, device₂ 406 generates a care-of test (CoT) message 418 in response to the CoTI message 414 and includes a care-of security token (e.g., a care-of keygen token) within the CoT message 418. This CoT message 418 is routed to the CoA address of device₁ 402. It should be appreciated that both the security token and the care-of security token can be encrypted with or within the HoT message 416 and CoT message 418, respectively, to avoid unauthorized access to these security tokens.

At 420, device₁ 402 generates a second CoTI message 420 comprising the care-of security token received from device₂ 406. The care-of security token can be encrypted prior to being embedded in the second CoTI message 420, or the CoTI message 420 and care-of security token can both be encrypted together. In one aspect of the subject disclosure, the CoTI message 420 is then tunneled to home agent 404. In an alternative aspect, the care-of security token received from device₂ 406 can be encrypted and included in the original BU message 408 sent by device₁ 402 to home agent 404. In this latter aspect, network communication diagram 400 begins with a direct CoTI/CoT communication (not depicted) between device₁ 402 and device₂ 406 (e.g., where home agent 404 has already established a BSA with device₂ 406), taking place prior to BU message 308. Thus, CoTI message 414 and CoT message 418 would not occur after the BU/BA exchange at 308 and 310 in this latter aspect. In either case, once home agent 404 obtains the care-of security token and the home security token, the home agent 404 initiates a BU message 422 to device₂ 406. To ensure security of the BU message 422, home agent 404 can include the HoA of device₁ 402 within BU message 422, include a cryptographic relationship between home agent 404 and device₁ 402 within BU message 422, specify a link to a digital certificate associated with home agent 404, or digitally sign BU message 422, or a combination thereof. Once secured, BU message 422 is forwarded to device₂ 406.

Upon receiving the BU message 422 from the HA, the CN checks its authenticity, and the relationship with the MN. Upon receiving BU message 422, device₂ 406 can first verify the message (422), and then authenticate a digital certificate or digital signature of home agent 404 as described herein. Upon successful verification and authentication, device₂ 406 generates a Home Agent Key (HAK) for secure communication with home agent 404. Additionally, device₂ 406 can extract a HoA of device₁ 402 included in the BU message 422 and bind the HoA with the HAK. This binding can then enable secure communication directly between device₂ 406 and device₁ 402.

In response to the BU message 422, device₂ 406 encrypts the HAK with a public key of home agent 404 and generates a BA message 424 that includes the encrypted HAK. This BA message 424 is routed to home agent 404. After processing BA message 424 and the encrypted HAK, home agent 404 can then establish a long lifetime bidirectional security association (BSA) with device₂ 406, based on the HAK. In addition, this long lifetime BSA enables home agent 404 to initiate additional RO communication sessions with device₂ 406. As a specific example, home agent 404 can establish an additional RO communication session by sending a subsequent BU message (not depicted) that includes the HAK (encrypted) as well as a CoA of a device served by home agent 404 (which can include device₁ 402 or another network device). In this manner, much of the control signaling (408-420) can be avoided when establishing these additional RO communication sessions. The new MN will not need to exchange any mobility signaling message with the CN.

After creating a Binding Cache Entry (BCE) for the HA and another one for the MN, the CN starts re-routing data packets to the MN's CoA. After receiving valid data packets from the CN at its new CoA, the MN can re-route its own traffic to the direct path with the CN. Once the BSA is created, the HA can encrypt the CoA field when sending subsequent BU messages to the CN.

Upon establishing a BSA with the HA, the CN may create one BCE which binds both the HA's IP address and public key to the HAK. Such a BCU encompasses all subsequent bindings between an MN's HoA and CoA, which are considered sub-bindings attached to the HA BCE. Switching to RO mode requires exchanging at least two pair of messages, as described in FIG. 4. However, by establishing a HAK between the HA and CN, only a BU message from the HA to the CN needs to be sent for future communication. This reduces the number of mobility signaling messages thereby reducing MN latency, because the HA update and the CN update can be done almost at the same time.

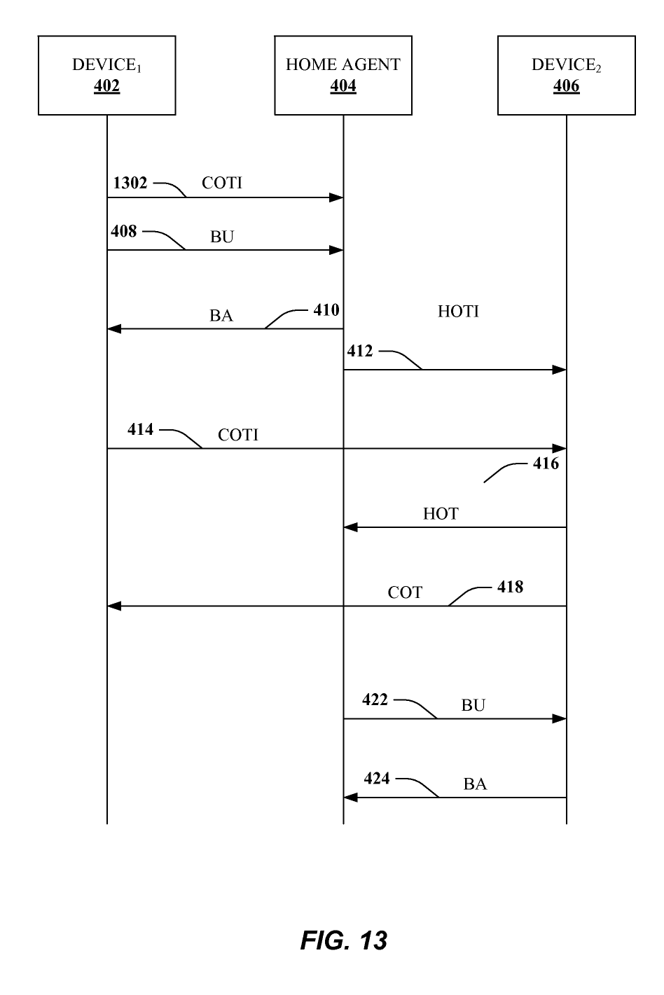

FIG. 13 illustrates an alternate signaling process in which the CoTI 1302 is sent prior to the BU 408 and BA 410 message exchange. The CoTI is usually sent when a MN changes location. Thus, this update may be sent prior to the BU 408 message, thereby avoiding the need to send CoTI 420 as in FIG. 4.

The approval/authorization and switching to RO is performed by the HA on behalf of the MN. The HA uses a certificate that provides the CN with enough insurance to establish a BSA with the HA. Using the HA certificate prevents a malicious node from emulating the HA role to establish a BSA with the CN. This prevents such a unauthorized node from using such a BSA to launch a flooding attack against a network.

Further, in order to prevent DoS attacks against a CN, the CN can withhold validating the signature carried in a BU message until it has checked the message authenticity, such as in part, verifying the cryptographic relationship with the MN as well as the certificate.

In order to mitigate the potential for a malicious MN to launch a flooding attach against a specific foreign network by leaving the network after updating its HA with its CoA, the HA can avoid sending a BU message to the CN on behalf of the MN until the MN's AR has disclosed to the HA its crypto-relationship with the MN. This relationship can then be used by the AR in order to request the CN to stop sending data packets in case it comes under a flooding attack. The HA can also act completely on its own with the MN's involvement in the signaling exchange, when receiving a request from the MN specifying the CN's identifier (e.g., IP address FQDN, etc). This request can be carried in the BU message and can trigger an immediate action on the HA side to switch the MN to the RO mode. For this purpose, the HA establishes an SA with the CN during which, it sends its certificate (or a link to it) which specifies its role as a HA.

The aforementioned systems and/or apparatuses have been described with respect to interaction between several components, modules and/or communication interfaces. It should be appreciated that such systems and components/modules/interfaces can include those components/modules or sub-modules specified therein, some of the specified components/modules or sub-modules, and/or additional modules. Sub-modules could also be implemented as modules communicatively coupled to other modules rather than included within parent modules. Additionally, it should be noted that one or more modules could be combined into a single module providing aggregate functionality. For instance, scanning module 308 can include transfer module 312, or vice versa, to facilitate identifying or inferring a route-optimized communication request and initiating route optimized communication by way of a single component. The components can also interact with one or more other components not specifically described herein but known by those of skill in the art.

Furthermore, as will be appreciated, various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, and in addition to that already described herein, can automate certain mechanisms or processes performed thereby to make portions of the systems and methods more adaptive as well as efficient and intelligent.

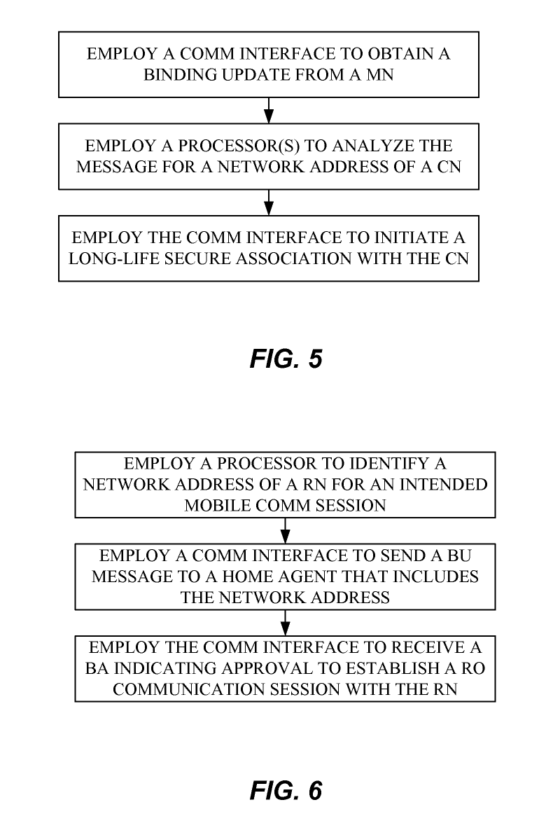

In view of the exemplary systems described supra, methodologies that may be implemented in accordance with the disclosed subject matter will be better appreciated with reference to the flow charts of FIGS. 5-7. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter. Additionally, it should be further appreciated that the methodologies disclosed hereinafter and throughout this specification are capable of being stored on an article of manufacture to facilitate transporting and transferring such methodologies to computers. The term article of manufacture, as used, is intended to encompass a computer program accessible from any computer-readable device, device in conjunction with a carrier, or storage medium.

FIG. 5 illustrates a flowchart of an example methodology 500 for a network-triggered RO communication sessions according to aspects of the subject disclosure. At 502, method 500 can comprise employing a communication interface to obtain a BU from a MN. Further, at 504, method 500 can comprise employing one or more data processors to analyze the BU for a network address of a CN. The CN can be any suitable node communicably coupled with a network accessible to the MN. In addition, the network address can comprise an Internet Protocol address, a fully qualified domain name (FQDN), or another suitable network identifier associated with the CN. At 506, method 500 can comprise employing the communication interface to initiate a long-life secure association between the CN and a network agent serving the MN if the BU message contains the network address of the CN. In addition, it should be appreciated that the long-life secure association between the CN and the network agent serving the MN can enable the MN and the CN to participate in a RO mobile communication for session, as described herein.

FIG. 6 illustrates a flowchart of a sample methodology 600 for facilitating network-triggered route optimized mobile communication according to one or more particular aspects disclosed herein. At 602, method 600 can comprise employing a data processor to identify a network address of a recipient node of an intended mobile communication session. The network address can be identified in response to an inbound communication received from a device initiating the intended mobile communication session. As an alternative, the network address can be identified as an address of a target device for the intended mobile communication session. In addition, it should be appreciated that the network address can comprise an IP address, a FQDN address, or some other suitable identifier for a node of a communication network.

At 604, method 600 can comprise employing a communication interface to send a binding update message to a home agent that includes the network address of the RN. In one aspect, the binding update message can comprise an explicit request for the intended mobile communication session to be established via a RO communication session. In an alternative aspect, including the network address of the RN within the binding update message can imply a request for the RO communication session with the RN. In at least one particular aspect, the binding update message can also comprise a security token (e.g., a care-of keygen token) obtained from the RN in a prior control message or a prior communication session established with the RN.

At 606, method 600 can comprise employing the communication interface to receive a binding acknowledgment from the home agent indicating approval to establish the RO mobile communication session with the RN, or optionally denying approval to establish the RO mobile communication session with the RN. As a particular example, approving or denying the RO mobile communication session can be based on whether a suitable network path exists for such RO mobile communication. In at least one specific aspect, the binding acknowledgment can comprise security protocol information (e.g., a HAK) suitable for securing the RO mobile communication from unauthorized access.

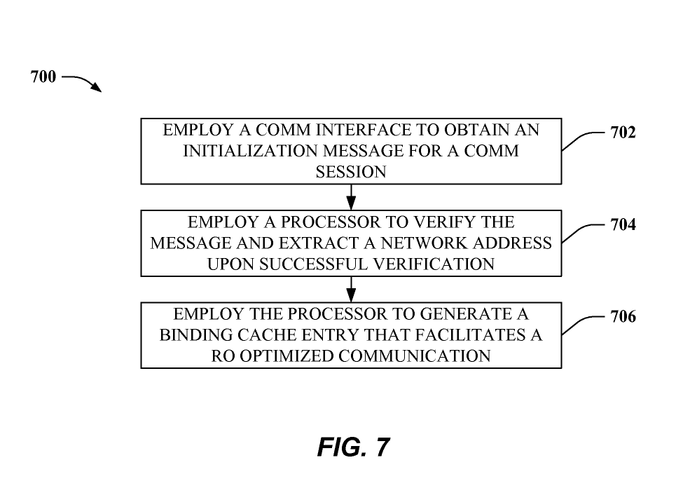

FIG. 7 illustrates a flow chart of an example methodology 700 for facilitating RO mobile communication according to still other aspects of the subject disclosure. At 702, method 700 can comprise employing a communication interface to obtain an initialization message pertaining to a desired mobile communication session. In one aspect of the subject disclosure, the initialization message can be transmitted directly from a communication device initiating the desired mobile communication session. In another aspect of the subject disclosure, the initialization message can be transmitted by a network component serving the communication device instead. In either case, the initialization message can comprise a home address of the communication device, which can facilitate communication with such device, with the network component, or both.

At 704, method 700 can comprise employing at least one data processor to verify the initialization message and extract a network address (e.g., the home address) of a network entity transmitting the initialization. In one aspect, extracting the network address can be conditioned on successful verification of the initialization message. In another aspect, method 700 can further authenticate the message upon successful verification. In this context, authentication can comprise verifying a digital certificate of the network entity, verifying a digital signature of the initialization message, verifying a cryptographic relationship between the network entity transmitting the initialization message and the communication device, or verifying the network address, or a suitable combination thereof At 706, method 700 can comprise employing the at least one data processor to generate a binding cache entry for the network entity or a network component serving the network entity. Specifically, the binding cache entry can include a security key that facilitates a route optimized communication session with the network entity or the network component. For instance, the security key can be bound with the network address, and traffic comprising the security key or originating from the network address can be authorized for the route optimized communication session. In addition, the security key can facilitate additional route optimized communication sessions, for the duration of a long-life bidirectional security association established in conjunction with the binding cache entry. These additional route optimized communication sessions can be initiated upon receiving the security key in conjunction with an additional network address different from the network address. Furthermore, such an additional network address can be bound within the binding cache entry with the security key, further facilitating subsequent communication based on the additional route optimized communication session(s).

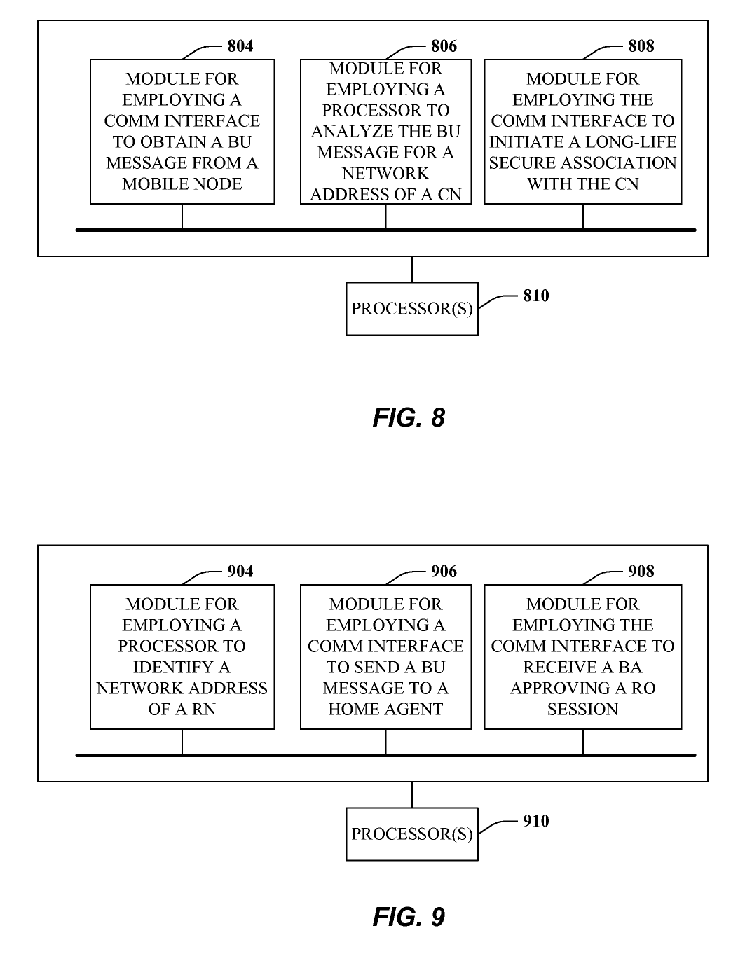

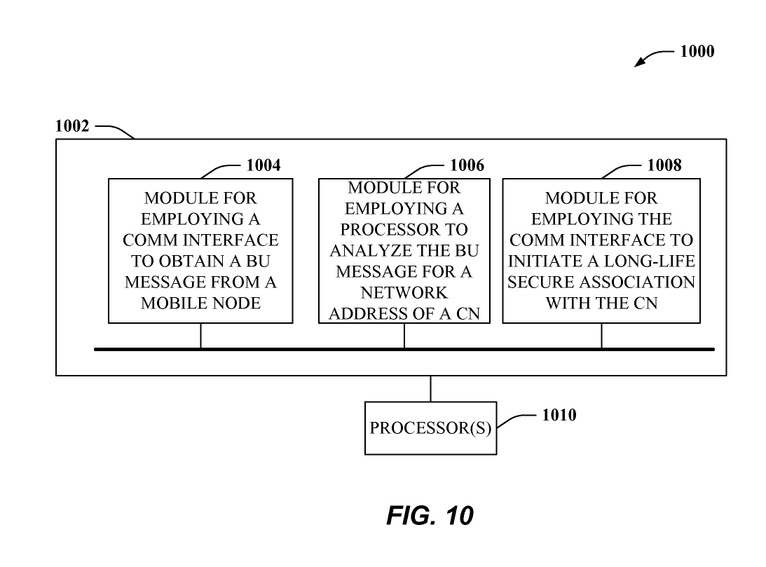

FIGS. 8, 9 and 10 depict block diagrams of example apparatuses 800, 900 and 1000 that can facilitate network-triggered route optimized mobile communication according to various aspects of the subject disclosure. For example, apparatuses 800, 900, 1000 can reside at least partially within a wireless communication network and/or within a transmitter such as a node, base station, access point, user terminal, personal computer coupled with a mobile interface card, or the like. It is to be appreciated that apparatuses 800, 900, 1000 are represented as including functional blocks, which can be functional blocks that represent functions implemented by a processor, software, or combination thereof (e.g., firmware).

Apparatus 800 can comprise memory 802 for storing modular instructions 804, 806, 808 that provide network-triggered route optimized communication for mobile network nodes. The modular instructions 804, 806, 808 can be executed by a data processor(s) 810 in conjunction with executing code. Furthermore, apparatus 800 can comprise a module 804 for employing a communication interface to obtain a binding update message from a mobile node. Moreover, apparatus 800 can comprise a module 806 for employing processor 810 to analyze the binding update message for a network address of a corresponding node. Additionally, apparatus 800 can comprise a module 808 for employing the communication interface to initiate a long-life secure association between the corresponding node and a network agent serving the mobile node if the binding update message contains the network address of the corresponding node. Furthermore, the long-life secure association can enable the mobile node and corresponding node to participate in a route optimized mobile communication session. More specifically, this session can be established by apparatus 800 on behalf of the mobile node. Moreover, the long-life secure association can form the basis of additional route optimized mobile communication sessions, as described herein. These additional route optimized mobile communication session can be established and released with reduced control signaling activity as a result of the long-life secure association. Accordingly, apparatus 800 can provide efficient and low latency mobile communication in various circumstances, improving overall mobile communication experience.

Apparatus 900 can comprise memory 902 for storing modular instructions 904, 906, 908 configured for requesting route optimized mobile communication, and a processor 910 for executing the modular instructions 904, 906, 908. Moreover, the modular instructions can comprise a module 904 for employing processor 910 to identify a network address of a recipient node of an intended mobile communication session. In at least one aspect, the intended mobile communication session can be initiated by apparatus 900. In an alternative aspect, however, the intended mobile communication session can be initiated by the recipient node. Furthermore, the modular instructions can comprise a module 906 for employing a communication interface to send a binding update message to a home agent. The binding update message can include a network address of the recipient node. In one alternative aspect, the binding update message can also comprise an explicit request to establish a route optimized communication session between apparatus 900 and the recipient node. In another alternative aspect, existence of the network address within the binding update message can imply a request to establish the route optimized communication session instead. Further to the above, the modular instructions can comprise a module 908 for employing the communication interface to receive a binding acknowledgment from the home agent indicating approval (or optionally denying approval) to establish the route optimized mobile communication session with the recipient node. Optionally, approval or denial of the route optimized communication session can be based at least in part on existence of a suitable network path linking apparatus 900 with the recipient node.

Apparatus 1000 can comprise memory 1002 for storing modular instructions 1004, 1006, 1008 configured for facilitating network-triggered route optimized mobile communication, and a processor 1010 for executing the modular instructions 1004, 1006, 1008. Particularly, the modular instructions can comprise a module 1004 for employing a communication interface to obtain an initialization message pertaining to a desired mobile communication session. Further, the modular instructions can comprise a module 1006 for employing processor 1010 to verify the initialization message. Upon successful verification, module 1006 can employ processor 1010 to extract a network address of a network entity transmitting the initialization message. Optionally, module 1006 can also employ the processor to authenticate security information associated with the initialization message as a condition to extracting the network address. In addition to the foregoing, the modular instructions can comprise a module 1008 for employing the processor 1010 to generate a binding cache entry for the network entity or a network component serving the network entity. In this context, the binding cache entry can include a security key that facilitates a route optimized communication session with the network entity or the network component. Accordingly, such binding cache entry can be employed for mitigating control signaling involved in establishing the route optimized communication session, or in establishing additional route optimized communication sessions, as described herein.

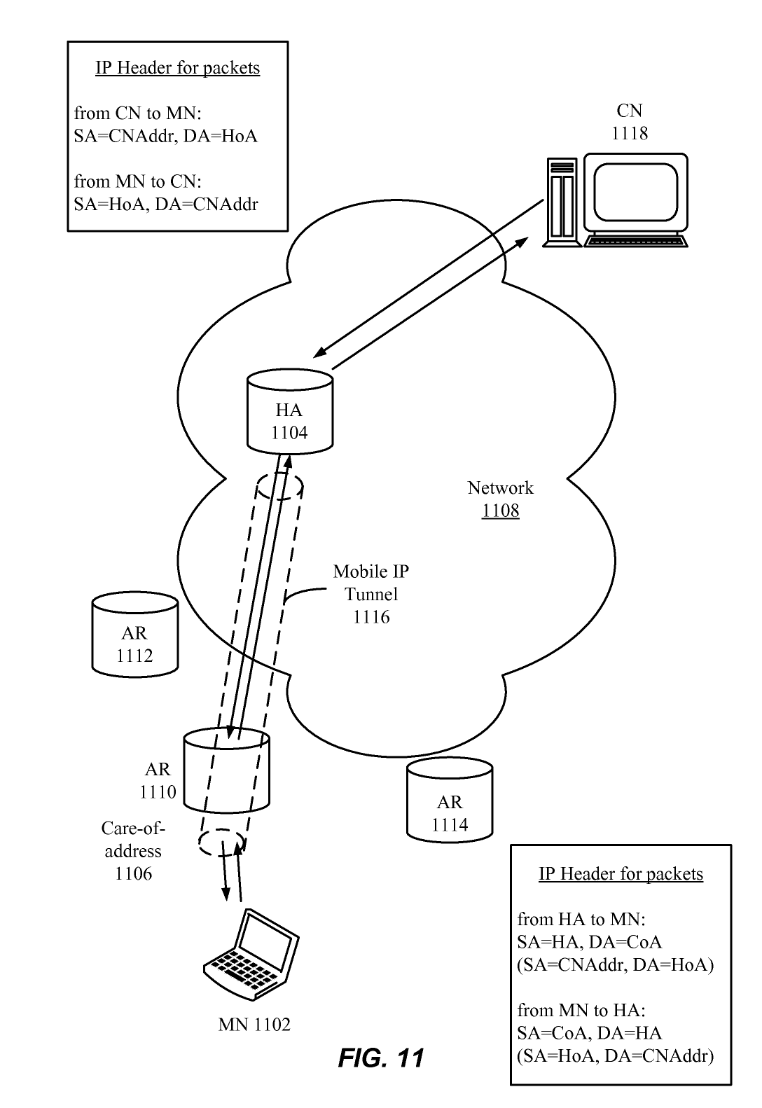

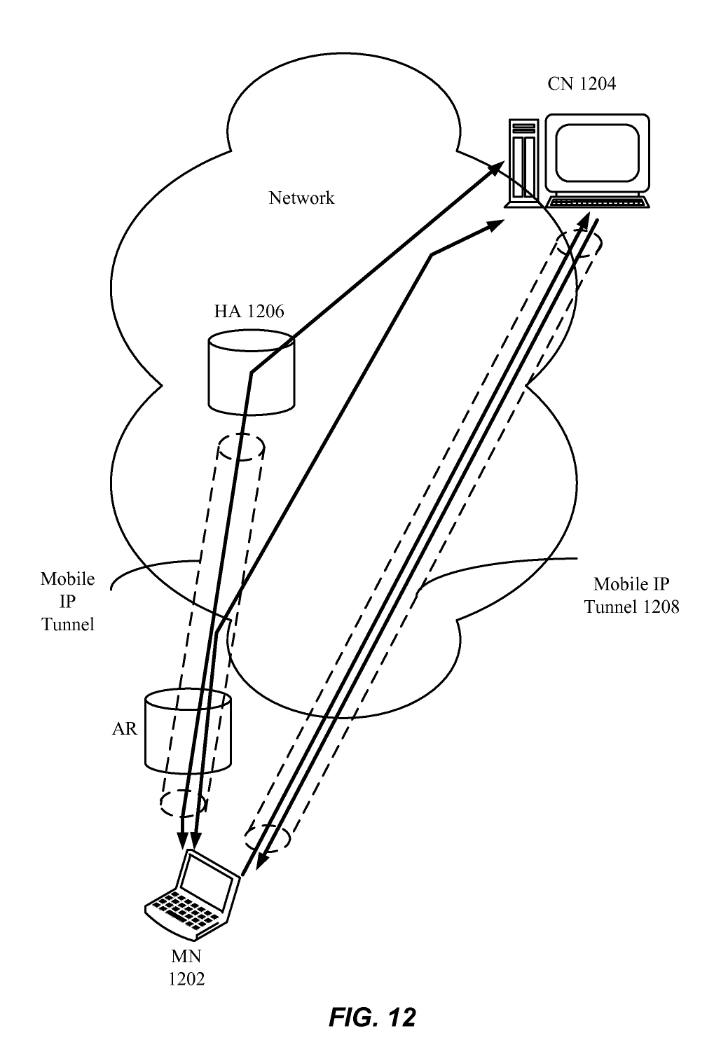

FIG. 11 illustrates MIPv6 that allows a MN 1102 to redirect traffic sent to its HA 1104 to its current location identified by a Care-of-Address CoA. The MN's HoA is routed to a HA which is at a fixed place in the Internet (e.g., at the MN's home network 1108). The MN gets an address (CoA) from whichever network it connects to at a time. For example, in FIG. 11, MN 1102 would receive a CoA from the network represented by AR 1110. MN would receive a different CoA if it was connected to 1112 or 1114. The MN then sends a Binding Update (BU) to its HA 1104, binding its HoA with its current CoA. Any packets received from a corresponding node CN 1118 at the HA on the MN's HoA are then tunneled to the MN's CoA via Mobile IP Tunnel 1116.

MIPv6 Route Optimization (RO) allows an MN 1202 to bypass the HA 1206 when it communicates with a given CN 1204. Using RO, MN 1202 could communicate directly with CN 1204 via mobile IP tunnel 1208. In the past this was entirely MN triggered and controlled. The HA 1206 could block the route optimization procedure by dropping HOT/HOTI messages exchanged between the MN 1202 and CN 1204 via the HA, but was not able to actively participate in the process.

Aspects described in connection with FIGS. 1-10 describe ways in which the HA can more actively participate in the RO process. As described above, the HA may perform MIPv6 RO to a given CN based on an optional request from an MN, or the HA can initiate RO without any trigger from the MN. The HA may determine whether RO to a given CN should be performed. This decision may be based on policy, such as whether RO would be beneficial in terms of a routing path. It is desirable to empower infrastructure to take decisions and act seamlessly on behalf of the MN whenever possible. It is highly desirable that the MN be able to consult with its home infrastructure, i.e. HA entity, prior to initiating a RO procedure with any CN. Thus, aspects describe herein allow the MN to consult with its HA and to delegate the RO switching mechanism. Aspects also relieve the MN from exchanging additional mobility signaling messages beyond one pair of mobility signaling message which will apply only in particular scenarios. Aspects further enable the HA and CN to build a long lifetime trust relationship and to create a new mobility context which will not require any mobility signaling message exchange between MNs and a CN in order to switch to the RO mode. Aspects also provide the network operator managing the home agent to have some control over the route optimization process. This control is important since a lot of services may require that the home agent be in the path, e.g. for accounting, and other reasons. In other cases, it may be difficult for the mobile node to assess whether route optimization can be beneficial or not. This may be based, at least in part, on whether there is a shorter routing path between the MN and the CN. In such cases, the home agent may exert control over route optimization in order to enable optimal performance.

These aspects do not exclude the host centric RO mode protocol, but can be used as another optimization to further reduce the amount of signaling messages and to decrease the amount of signaling messages.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal (AT), user terminal, terminal, communication device, user agent (UA), user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method of wireless communication, comprising:
employing a communication interface to obtain a binding update message from a mobile node (MN);
employing a data processor to analyze the binding update message for a network address of a corresponding node (CN); and
employing the communication interface to initiate a long-life secure association between the CN and a network agent serving the MN if the binding update message contains the network address of the CN, wherein the long-life secure association enables the MN and CN to participate in a route optimized (RO) mobile communication session.

2. The method of claim 1, further comprising interpreting the binding update message as a request to establish the RO mobile communication session if the binding update message includes the network address of the CN.

3. The method of claim 1, further comprising conditioning initiation of the long-life secure association on determining whether an efficient RO path exists for the MN and CN.

4. The method of claim 1, further comprising initiating a home test initialization (HoTI) message to the CN on behalf of the MN.

5. The method of claim 4, further comprising at least one of:
employing a home address (HoA) of the MN as a source address (SA) for the HoTI message; or
employing a network address of the network agent serving the MN as the SA and including the HoA of the MN within a payload of the HoTI message.

6. The method of claim 4, further comprising receiving a security token from the CN in response to the HoTI message.

7. The method of claim 1, further comprising obtaining an encrypted message from the MN comprising a care-of security token pertaining to the RO mobile communication session.

8. The method of claim 7, wherein the encrypted message is the binding update message, which in turn includes the care-of security token.

9. The method of claim 1, wherein employing the communication interface to initiate the long-life secure association further comprises sending a second binding update message on behalf of the MN to the CN.

10. The method of claim 9, wherein the second binding update message includes a network address of the network agent serving the MN as a source address (SA).

11. The method of claim 9, wherein the second binding update message includes a home address (HoA) of the MN.

12. The method of claim 9, wherein the second binding update message discloses a cryptographic relationship between the MN and the network agent serving the MN.

13. The method of claim 9, wherein the second binding update message provides a link to a security certificate associated with the network agent serving the MN.

14. The method of claim 9, wherein the second binding update message is cryptographically signed by the network agent serving the MN.

15. The method of claim 9, further comprising conditioning sending the second binding update message on receiving authentication of a cryptographic relationship between the MN and a network router serving the MN.

16. The method of claim 1, further comprising:
employing the communication interface to receive a response to the long-life secure association comprising a network agent encryption key, and
employing the network agent encryption key to generate a long-life bidirectional security association (BSA) between the CN and the network agent serving the MN.

17. The method of claim 15, further comprising initiating an additional RO mobile communication session with the CN for a second MN utilizing the network agent encryption key and a network address of the second MN, wherein the additional RO mobile communication session obviates mobility signaling messages between the CN and the second MN.

18. The method of claim 15, further comprising encrypting a care-of address field in a subsequent binding update message sent to the CN as part of the long-life BSA.

19. The method of claim 1, further comprising sending an encryption certificate to the CN as part of the long-life security association to validate the network agent serving the MN with the CN.

20. An apparatus for wireless communication, comprising:
a communication interface that obtains a binding update message from a mobile node (MN); and
a data processor that executes a set of modules configured to provide network triggered route optimized (RO) mobile communication, the set of modules comprising:
a scanning module that analyzes the binding update message for a network address of a corresponding node (CN); and
a transfer module that initiates a long-life secure association between the CN and a network agent serving the MN if the binding update message contains the network address of the CN, wherein the long-life secure association enables the MN and CN to participate in a RO mobile communication session.

21. The apparatus of claim 20, wherein the scanning module is configured to interpret the binding update message as a request to establish the RO mobile communication session if the binding update message includes the network address of the CN.

22. The apparatus of claim 20, wherein the transfer module is configured to condition initiation of the long-life secure association based on determining whether an efficient RO path exists for the MN and CN.

23. The apparatus of claim 20, wherein the transfer module is configured to initiate a home test initialization (HoTI) message to the CN on behalf of the MN.

24. The apparatus of claim 23, wherein a home address (HoA) of the MN is used as a source address (SA) for the HoTI message; or a network address of the network agent serving the MN is used as the SA and including the HoA of the MN within a payload of the HoTI message.

25. The apparatus of claim 23, wherein the communication interface is configured to receive a security token from the CN in response to the HoTI message.

26. The apparatus of claim 20, wherein the processor is configured to obtain an encrypted message from the MN comprising a care-of security token pertaining to the RO mobile communication session.

27. The apparatus of claim 26, wherein the encrypted message is the binding update message, which in turn includes the care-of security token.

28. The apparatus of claim 20, wherein the communication interface is further configured to send a second binding update message on behalf of the MN to the CN.

29. The apparatus of claim 28, wherein the second binding update message includes a network address of the network agent serving the MN as a source address (SA).

30. The apparatus of claim 28, wherein the second binding update message includes a home address (HoA) of the MN.

31. The apparatus of claim 28, wherein the second binding update message discloses a cryptographic relationship between the MN and the network agent serving the MN.

32. The apparatus of claim 28, wherein the second binding update message provides a link to a security certificate associated with the network agent serving the MN.

33. The apparatus of claim 28, wherein the second binding update message is cryptographically signed by the network agent serving the MN.

34. The apparatus of claim 28, wherein the communication interface is further configured to condition sending the second binding update message on receiving authentication of a cryptographic relationship between the MN and a network router serving the MN.

35. The apparatus of claim 20, wherein the communication interface is configured to receive a response to the long-life secure association comprising a network agent encryption key, wherein the processor is configured to use the network agent encryption key to generate a long-life bidirectional security association (BSA) between the CN and the network agent serving the MN.

36. The apparatus of claim 35, wherein the transfer module is further configured to initiate an additional RO mobile communication session with the CN for a second MN utilizing the network agent encryption key and a network address of the second MN, wherein the additional RO mobile communication session obviates mobility signaling messages between the CN and the second MN.

37. The apparatus of claim 35, wherein the processor is further configured to encrypt a care-of address field in a subsequent binding update message sent to the CN as part of the long-life BSA.

38. The apparatus of claim 20, wherein the communication interface is further configured to send an encryption certificate to the CN as part of the long-life security association to validate the network agent serving the MN with the CN.

39. An apparatus for wireless communication, comprising:
means for obtaining a binding update message from a mobile node (MN);
means for analyzing the binding update message for a network address of a corresponding node (CN); and
means for initiating a long-life secure association between the CN and a network agent serving the MN if the binding update message contains the network address of the CN, wherein the long-life secure association enables the MN and CN to participate in a route optimized (RO) mobile communication session.

40. At least one processor configured for wireless communication, comprising:
a module that obtains a binding update message from a mobile node (MN);
a module that analyzes the binding update message for a network address of a corresponding node (CN); and
a module that initiates a long-life secure association between the CN and a network agent serving the MN if the binding update message contains the network address of the CN, wherein the long-life secure association enables the MN and CN to participate in a route optimized (RO) mobile communication session.

41. A computer program product, comprising:
a non-transitory computer-readable medium, comprising:
code for causing a computer to obtain a binding update message from a mobile node (MN);
code for causing the computer to analyze the binding update message for a network address of a corresponding node (CN); and
code for causing the computer to initiate a long-life secure association between the CN and a network agent serving the MN if the binding update message contains the network address of the CN, wherein the long-life secure association enables the MN and CN to participate in a route optimized (RO) mobile communication session.

42. A method of wireless communication, comprising:
employing a data processor to identify a network address of a recipient node (RN) of an intended mobile communication session;
employing a communication interface to send a binding update message to a home agent that includes the network address of the RN; and
employing the communication interface to receive a binding acknowledgement from the home agent indicating approval to establish a route optimized (RO) mobile communication session with the RN.

43. The method according to claim 42, wherein the approval of an established route optimized communication session with the RN is based in part on a security token from a Home Test (HOT) message from the RN and in part on a security token from a Care-of-Test (COT) message from the RN.

44. An apparatus for wireless communication, comprising:
a data processor configured to identify a network address of a recipient node (RN) of an intended mobile communication session; and
a communication interface configured to send a binding update message to a home agent that includes the network address of the RN and to receive a binding acknowledgement from the home agent indicating approval to establish a route optimized (RO) mobile communication session with the RN.

45. The apparatus according to claim 44, wherein the approval of an established route optimized communication session with the RN is based in part on a security token from a Home Test (HOT) message from the RN and in part on a security token from a Care-of-Test (COT) message from the RN.

46. An apparatus for wireless communication, comprising:
means for identifying a network address of a recipient node (RN) of an intended mobile communication session;
means for sending a binding update message to a home agent that includes the network address of the RN; and
means for receiving a binding acknowledgement from the home agent indicating approval to establish a route optimized (RO) mobile communication session with the RN.

47. At least one processor configured for wireless communication, comprising:
a module that identifies a network address of a recipient node (RN) of an intended mobile communication session;
a module that sends a binding update message to a home agent that includes the network address of the RN; and
a module that receives a binding acknowledgement from the home agent indicating approval to establish a route optimized (RO) mobile communication session with the RN.

48. A computer program product, comprising:
a non-transitory computer-readable medium, comprising:
code for causing a computer to identify a network address of a recipient node (RN) of an intended mobile communication session;
code for causing the computer to send a binding update message to a home agent that includes the network address of the RN; and
code for causing the computer to receive a binding acknowledgement from the home agent indicating approval to establish a route optimized (RO) mobile communication session with the RN.

49. A method of wireless communication, comprising:
employing a communication interface to obtain an initialization message pertaining to a desired mobile communication session;
employing at least one data processor to verify the initialization message and extract a network address of a network entity transmitting the initialization message upon successful verification; and
employing the at least one data processor to generate a binding cache entry for the network entity or a network component serving the network entity, wherein the binding cache entry includes a security key that facilitates a route optimized communication session with the network entity or the network component.

50. The method according to claim 49, transmitting at least a portion of the security key in a Home Test (HOT) message.

51. The method according to claim 49, further comprising:
transmitting at least a portion of the security key in a Care-of-Test (COT) message.

52. An apparatus for wireless communication, comprising:
a communication interface configured to obtain an initialization message pertaining to a desired mobile communication session;
at least one data processor configured to verify the initialization message and extract a network address of a network entity transmitting the initialization message upon successful verification and to generate a binding cache entry for the network entity or a network component serving the network entity, wherein the binding cache entry includes a security key that facilitates a route optimized communication session with the network entity or the network component.

53. The apparatus according to claim 51, wherein the communication interface is configured to transmit at least a portion of the security key in a Home Test (HOT) message.

54. The apparatus according to claim 51, wherein the communication interface is configured to transmit at least a portion of the security key in a Care-of-Test (COT) message.

55. An apparatus for wireless communication, comprising:
means for obtaining an initialization message pertaining to a desired mobile communication session;
means for verifying the initialization message and extract a network address of a network entity transmitting the initialization message upon successful verification; and
means for generating a binding cache entry for the network entity or a network component serving the network entity, wherein the binding cache entry includes a security key that facilitates a route optimized communication session with the network entity or the network component.

56. At least one processor configured for wireless communication, comprising:
a module that obtains an initialization message pertaining to a desired mobile communication session;
a module that verifies the initialization message and extract a network address of a network entity transmitting the initialization message upon successful verification; and
a module that generates a binding cache entry for the network entity or a network component serving the network entity, wherein the binding cache entry includes a security key that facilitates a route optimized communication session with the network entity or the network component.

57. A computer program product, comprising:
a non-transitory computer-readable medium, comprising:
code for causing a computer to obtain an initialization message pertaining to a desired mobile communication session;
code for causing the computer to verify the initialization message and extract a network address of a network entity transmitting the initialization message upon successful verification; and
code for causing the computer to generate a binding cache entry for the network entity or a network component serving the network entity, wherein the binding cache entry includes a security key that facilitates a route optimized communication session with the network entity or the network component.
